(19) United States
(12) Patent Application Publication
(10) Pub. No.: US 2017/0017522 A1
(43) Pub. Date: Jan. 19, 2017

(54) METHODS AND SYSTEMS FOR ASSIGNING RESOURCES TO A TASK

(71) Applicant: XEROX CORPORATION, Norwalk, CT (US)

(72) Inventors: Mohit Daga, Jaipur (IN); Manoj Gupta, Bangalore (IN); Koyel Mukherjee, Bangalore (IN); Shailesh Vaya, Bangalore (IN)

(21) Appl. No.: 14/799,835

(22) Filed: Jul. 15, 2015

(51) Int. Cl. G06F 9/50

(52) U.S. Cl. CPC G06F 9/505

(57) ABSTRACT

According to embodiments illustrated herein there is provided a method for assigning one or more resources to a task. The method includes determining one or more workflows, comprising one or more sub-tasks in a sequence, utilizable to process the task. The method further includes determining a set of scores for each sub-task associated with each workflow based on at least a set of performance attributes of a set of resources who are available for processing each sub-task. The disclosed method further includes assigning at least a resource from the set of resources, available for processing each sub-task, based on at least one of the determined set of scores and one or more predefined requisites associated with each sub-task.

### TECHNICAL FIELD

The presently disclosed embodiments are related, in general, to processing a task. More particularly, the presently disclosed embodiments are related to methods and systems for assigning one or more resources to the task.

### BACKGROUND

Current organizations in market offer a myriad of complex products and services. To support the development of these products and services, an organization may initiate one or more tasks that may require one or more resources with an appropriate set of skills to process the one or more tasks. Usually, the one or more resources are assigned to such tasks based on their respective availability and skills. However, the assignment of the one or more resources to such tasks may not consider the overall requirements of the tasks such as cost, delay, and accuracy. In such a scenario, this may lead to an increase in the cost of the tasks, an unnecessary delay in the completion of the tasks, and a reduced accuracy. Therefore, there is a need for a robust solution for assigning the one or more resources to the tasks.

### SUMMARY

According to embodiments illustrated herein, there is provided a method for assigning one or more resources to a task. The method includes determining, by one or more processors, one or more workflows utilizable to process the task. Each of the one or more workflows corresponds to a sequence of processing of one or more sub-tasks to process the task. The method further includes determining, by an arithmetic logic unit in the one or more processors, a first set of scores for a first sub-task corresponding to each workflow, from the one or more sub-tasks, based on at least a first set of performance attributes of a first set of resources. The first set of resources are resources available to process the first sub-task in each workflow. The first set of scores is indicative of availability of the first set of resources to process the first sub-task corresponding to each of the one or more workflows. The method further includes assigning, by the one or more processors, at least a resource from the first set of resources to the first sub-task based on at least one of the determined first set of scores and one or more predefined requisites associated with the first sub-task.

According to embodiments illustrated herein, there is provided a system for assigning one or more resources to a task. The system includes one or more processors configured to determine one or more workflows utilizable to process the task. Each of the one or more workflows corresponds to a sequence of processing of one or more sub-tasks to process the task. The one or more processors are further configured to determine, by an arithmetic logic unit, a first set of scores for a first sub-task corresponding to each workflow, from the one or more sub-tasks, based on at least a first set of performance attributes of a first set of resources. The first set of resources are resources available to process the first sub-task in each workflow. The first set of scores is indicative of availability of the first set of resources to process the first sub-task corresponding to each of the one or more workflows. The one or more processors are further configured to assign at least a resource from the first set of resources to the first sub-task based on at least one of the determined first set of scores and one or more predefined requisites associated with the first sub-task.

According to embodiments illustrated herein, there is provided a method for assigning one or more resources to a task. The method includes determining, by one or more processors, one or more workflows utilizable to process the task. Each of the one or more workflows corresponds to a sequence of processing of one or more sub-tasks to process the task. The method further includes determining, by an arithmetic logic unit in the one or more processors, a first set of scores for a first sub-task corresponding to each workflow, from the one or more sub-tasks, based on at least a first set of performance attributes of a first set of resources. The first set of resources are resources available to process the first sub-task in each workflow. The first set of scores is indicative of availability of the first set of resources to process the first sub-task corresponding to each of the one or more workflows. The method further includes assigning, by the one or more processors, at least a resource from the first set of resources to the first sub-task based on at least one of the determined first set of scores and one or more predefined requisites associated with the first sub-task. The method further includes comparing, by a comparator in the one or more processors, a workflow's performance attributes of the workflow with the workflow's performance attributes of remaining one or more workflows. The method further includes selecting, by the one or more processors, at least the workflow, from the one or more workflows, based on at least the comparison.

According to embodiments illustrated herein, there is provided a computer program product for use with a computer. The computer program product includes a non-transitory computer readable medium. The non-transitory computer readable medium stores a computer program code for assigning one or more resources to a task. The computer program code is executable by one or more processors configured to determine one or more workflows utilizable to process the task. Each of the one or more workflows corresponds to a sequence of processing of one or more sub-tasks to process the task. The computer program code is further executable by the one or more processors configured to determine, by an arithmetic logic unit, a first set of scores for a first sub-task corresponding to each workflow, from the one or more sub-tasks, based on at least one of a first set of performance attributes of a first set of resources. The first set of resources are resources available to process the first sub-task in each workflow. The first set of scores is indicative of availability of the first set of resources to process the first sub-task corresponding to each of the one or more workflows. The computer program code is further executable by the one or more processors configured to assign at least a resource from the first set of resources to the first sub-task based on at least one of the determined first set of scores and one or more predefined requisites associated with the first sub-task.

According to embodiments illustrated herein, there is provided a computer program product for use with a computer. The computer program product includes a non-transitory computer readable medium. The non-transitory computer readable medium stores a computer program code for assigning one or more resources to a task. The computer program code is executable by one or more processors configured to determine one or more workflows utilizable to process the task. Each of the one or more workflows corresponds to a sequence of processing of one or more sub-tasks to process the task. The computer program code is further executable by the one or more processors configured to determine, by an arithmetic logic unit, a first set of scores for a first sub-task corresponding to each workflow, from the one or more sub-tasks, based on at least one of a first set of performance attributes of a first set of resources. The first set of resources are resources available to process the first sub-task in each workflow. The first set of scores is indicative of availability of the first set of resources to process the first sub-task corresponding to each of the one or more workflows. The computer program code is further executable by the one or more processors configured to assign at least a resource from the first set of resources to the first sub-task based on at least one of the determined first set of scores and one or more predefined requisites associated with the first sub-task. The computer program code is further executable by a comparator configures to compare a workflow's performance attributes of the workflow with the workflow's performance attributes of remaining one or more workflows. The computer program code is further executable by the one or more processors configured to select at least the workflow, from the one or more workflows, based on at least the comparison.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for assigning one or more resources to a task, in accordance with at least one embodiment;

FIGS. 3A and 3B are flowcharts illustrating a method for assigning one or more resources to a task, in accordance with at least one embodiment;

FIG. 4 is a graph illustrating one or more sub-tasks and one or more workflows, in accordance with an embodiment;

FIG. 5 is a flowchart illustrating a method for assigning a resource to the first sub-task based on the first set of scores, in accordance with at least one embodiment;

FIG. 6A is a is a block diagram illustrating a graphical user interface (GUI) utilized by a requestor for viewing and assigning the resources to a task, in accordance with at least one embodiment;

FIG. 6B is a block diagram illustrating a GUI utilized by a requestor for selecting a task, in accordance with at least one embodiment; and

FIG. 6C is a block diagram illustrating a GUI utilized by a requestor for assigning resources to a task, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system that performs one or more operations according to one or more programming instructions/codes. Examples of a computing device may include, but are not limited to, a desktop computer, a laptop, a personal digital assistant (PDA), a mobile device, a smartphone, a tablet computer (e.g., iPad®, and Samsung Galaxy Tab®), and the like.

A “requestor” refers to an individual and/or an organization that requests, using a computing device, to assign one or more resources to each of one or more tasks. The requestor may utilize the computing device to perform one or more operations such as assigning the one or more resources to the one or more tasks. In an embodiment, the requestor may correspond to a worker, a manager, a project manager, a staffing manager, and/or a hiring manager associated with each task at the organization.

“One or more resources” refer to materials, individuals, machines, and other assets that may be used/utilized by a requestor to carry out one or more operations associated with one or more tasks. The one or more resources may comprise at least one or more of, but are not limited to, one or more employees, one or more crowdsourcing platforms, one or more organizations, one or more hardware and one or more software. Further, each of the one or more resources may be associated with one or more performance attributes such as a cost, a time, and an accuracy incurred for processing the one or more tasks. For example, an employee charges $100 to process a task in 5 hours.

A “crowdsourcing platform” refers to a business application, wherein a broad, loosely defined external group of people, a community, or an organization provides solutions as outputs for any specific task processes received by the application as an input. In an embodiment, the business application may be hosted online on a web portal (e.g., crowdsourcing platform servers). Various examples of the crowdsourcing platform include, but are not limited to, Amazon Mechanical Turk or Crowd Flower.

A “task” refers to a project, a service, an activity, or a job that may be performed by one or more resources. The task may comprise a set of inter-related tasks planned for execution over a period of time. The task (or each of the inter-related tasks i.e., one or more sub-tasks) may have one or more constraints such as a cost constraint, a time constraint, and an accuracy constraint. In an embodiment, the task may be executed in such a manner that the one or more constraints are met. The task may include instructions on how to perform the task. Further, the task may comprise one or more features. Examples of the task features may include, but are not limited to, a day of submitting the task, a deadline for completing the task, the cost constraint associated with the task, and so forth.

A “sub-task” refers to a micro task of a task. One or more sub-tasks may constitute the task. Further, the one or more sub-tasks may be inter-dependent on each other in a sequence, i.e., a second sub-task can only be performed after the completion of a first task. Further, each of the one or more sub-tasks may have one or more predefined requisites/constraints such as, but not limited to, a cost constraint, a time constraint, and an accuracy constraint. Hereinafter, “sub-task” and “micro-task” has been interchangeably used.

“One or more workflows” refer to one or more modes of processing a task. In an embodiment, each workflow/mode may comprise one or more sub-tasks that may be processed in a sequence so as to process the task. In an embodiment, the workflow may further define the interdependency among the one or more sub-tasks (that are part of the workflow). For example, a workflow defines a dependency of a second sub-task on a first sub-task. In such a case, the second sub-task may not be processed unless the first sub-task has been processed.

A “set of scores” refers to a set of numerical values associated with each of one or more sub-tasks. In an embodiment, the set of scores corresponding to a sub-task may be indicative of availability of resources to process the sub-task. In an embodiment, the set of scores may be represented in a multidimensional matrix/data structure.

A “first set of performance attributes” refers to a set of numerical values, which may be a representative of a performance of each of one or more resources based on at least a processing of one or more sub-tasks. The first set of performance attributes associated with each of the one or more resources may comprise a measure of one or more of, but not limited to, a cost of processing a sub-task, a delay in processing the sub-task, or an accuracy of processing the sub-task.

A “graph” refers to an index that may be a representative of one or more workflows for processing a task. In an embodiment, as discussed, each of the one or more workflows may comprise one or more sub-tasks, which when processed individually may lead to processing of the task as a whole. In an embodiment, in the graph, each workflow may comprise one or more nodes and one or more edges. In an embodiment, each node may be a representative of the sub-task in the workflow. Further, each edge connecting two sub-tasks, may represent an interdependency between the two sub-tasks. In an embodiment, the interdependency may be deterministic of a sequence of processing the two sub-tasks. In an embodiment, the graph may be a directed acyclic graph. Hereinafter, the terms “graph”, “directed acyclic graph”, and are used interchangeably.

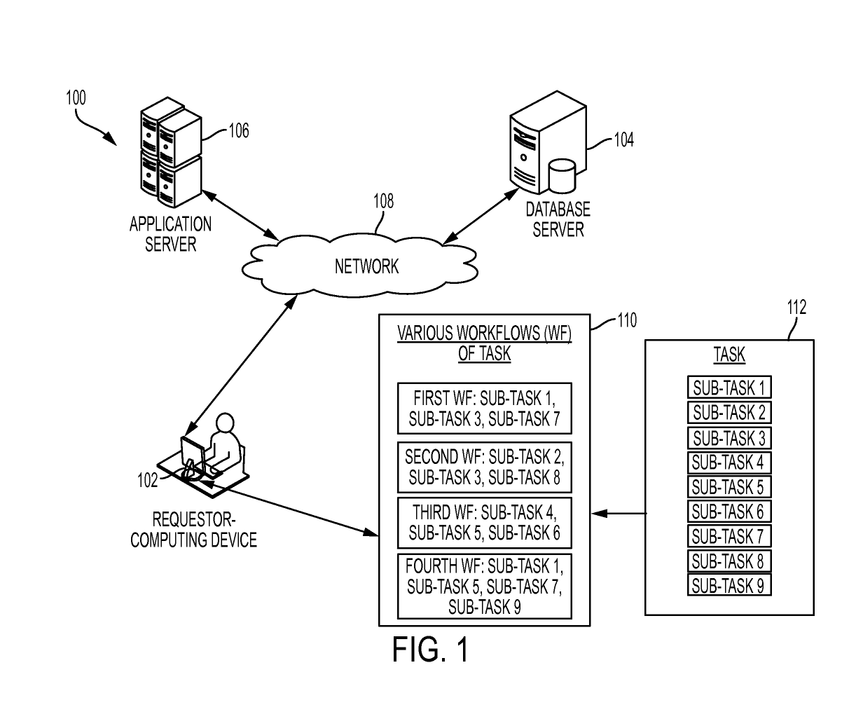

FIG. 1 is a block diagram illustrating a system environment 100 in which various embodiments may be implemented. The system environment 100 includes a requestor-computing device 102, a database server 104, an application server 106, and a network 108. Various devices in the system environment 100 may be interconnected over the network 108. FIG. 1 shows, for simplicity, one requestor-computing device 102, one database server 104, and one application server 106. However, it will be apparent to a person having ordinary skill in the art that the disclosed embodiments may also be implemented using multiple requestor-computing devices 102, multiple database servers 104, and multiple applications servers 106.

The requestor-computing device 102 refers to a computing device used by a requestor. The requestor may correspond to at least one of, but not limited to, a manager, a project manager, a staffing manager, and a hiring manager. The requestor-computing device 102 may comprise one or more processors in communication with one or more memories. The requestor-computing device 102 may be operable to execute one or more sets of instructions stored in the one or more memories. In an embodiment, the requestor-computing device 102 may comprise a display screen that may be configured to display one or more user interfaces to the requestor. In an embodiment, the requestor-computing device 102 may be communicatively coupled over the network 108. In an embodiment, the requestor may utilize the requestor-computing device 102 to transmit a task or one or more sub-tasks (e.g., sub-task 1, sub-task 2, etc., corresponding to the task (depicted by 112)) to the database server 104 and/or the application server 106 over the network 108. Further, in an embodiment, the requestor may transmit an associated information of the task (or the one or more sub-tasks) to the database server 104 and/or the application server 106. The associated information of the one or more sub-tasks (or the task) may comprise, one or more of, but not limited to, one or more requisites/constraints (e.g., a cost constraint, a delay constraint, an accuracy constraint, etc.) associated with each sub-task, a deadline for processing each sub-task, and one or more skills required for processing each sub-task. Further, in an embodiment, the associated information may comprise one or more instructions for processing each of the one or more sub-tasks (or the task). For example, if a task corresponds to a digitization of a handwritten document, the requestor may transmit, using the requestor-computing device 102, one or more documents that include the handwritten content. In another embodiment, the requestor may transmit one or more workflows (e.g., depicted by 110) associated with the task. In an embodiment, each workflow may comprise the one or more sub-tasks that may be processed in a sequence so as to process the task as a whole. Further, in an embodiment, the requestor may utilize the requestor-computing device 102 to transmit a set of performance attributes of each one or more resources to the database server 104 and/or the application server 106. The set of performance attributes of each of the one or more resources may comprise at least a measure of one or more of, but is not limited to, a cost of processing a sub-task, a delay in processing the sub-task, and an accuracy of processing the sub-task. Further, the requestor may transmit historical records of the one or more resources to the database server 104 and/or the application server 106. The historical records of each resource may comprise one or more of, but are not limited to, time took by each resource to process one or more historical sub-tasks (or historical tasks), the accuracy achieved by each resource on the one or more historical sub-tasks (or the historical tasks), and the cost charged by each resource to process the one or more historical sub-tasks (or the historical tasks). Further, the historical records may comprise one or more skills of each of the one or more resources. In an embodiment, the requestor may utilize one or more user interfaces, displayed on the display screen of the requestor-computing device 102, to transmit one or more of, but not limited to, the task (or the one or more sub-tasks), the associated information of the task (or the one or more sub-tasks), the one or more workflows of the task, and the historical records of the one or more resources.

Further, in an embodiment, the requestor may utilize the requestor-computing device 102 to provide one or more input pertaining to an assignment of the one or more resources to the one or more sub-tasks (or the task). Further, in an embodiment, the requestor may be presented with a user interface on the display screen of the requestor-computing device 102 displaying one or more assigned resources to the one or more sub-tasks of the task.

The requestor-computing device 102 may correspond to various types of computing devices such as, but not limited to, a desktop computer, a laptop, a personal digital assistant (PDA), a mobile device, a smartphone, a tablet computer (e.g., iPad® and Samsung Galaxy Tab®), and the like.

The database server 104 may refer to a computing device that may store the task and the one or more sub-tasks of the task, in accordance with at least one embodiment. Further, in an embodiment, the database server 104 may store the one or more workflows comprising the one or more sub-tasks of the task. In an embodiment, the database server 104 may receive one or more of, but not limited to, the task, the one or more sub-tasks of the task, and the one or more workflows associated with the task from the requestor-computing device 102. In an embodiment, the database server 104 may further store the associated information and the one or more instructions/features pertaining to the processing of each of the one or more sub-tasks (or the task). Further, in an embodiment, the database server 104 may store the historical records of the one or more resources. In an embodiment, the database server 104 may send one or more queries to one or more databases of one or more organizations to extract the historical records pertaining to each of the one or more resources. In another embodiment, the database server 104 may receive the historical records from the requestor-computing device 102.

In an embodiment, the database server 104 may be communicatively coupled with the network 108. In an embodiment, the database server 104 may be configured to transmit or receive the one or more instructions/tasks/sub-tasks/associated information/features to/from one or more devices, such as the requestor-computing device 102, and the application server 106 over the network 108. In an embodiment, the database server 104 may receive a query from the application server 106 to retrieve the task (or the one or more sub-tasks) and the associated information and/or the historical records pertaining to the one or more resources. For querying the database server 104, one or more querying languages may be utilized such as, but are not limited to, SQL, QUEL, DMX and so forth. Further, the database server 104 may be realized through various technologies such as, but not limited to, Microsoft® SQL server, Oracle, and My SQL.

The application server 106 may refer to a computing device or a software framework that may provide a generalized approach to create the application-server implementation. In an embodiment, the function of the application server 106 may be dedicated to the efficient execution of procedures such as, but not limited to, programs, routines, or scripts stored in one or more memories for supporting its applied applications. In an embodiment, the application server 106 may extract one or more of, but not limited to, the task, the one or more sub-tasks of the task, the one or more workflows comprising the one or more sub-tasks, and the associated information from the database server 104 over the network 108. In another embodiment, the application server 106 may receive one or more of, but not limited to, the task, the one or more sub-tasks of the task, the one or more workflows comprising the one or more sub-tasks, and the associated information from the requestor-computing device 102 over the network 108. Further, in an embodiment, the application server 106 may be operable to host an application/tool/framework for creating the one or more sub-tasks from the task. Thereafter, the application server 106 may create the one or more workflows comprising the created/received one or more sub-tasks, based on at least the associated information and the one or more instructions, in accordance with at least one embodiment. In an embodiment, the requestor may access the application server 106 over the network 108 to submit the associated information and the one or more instructions pertaining to the task or the one or more sub-tasks (e.g., through a web-based interface). Further, in an embodiment, the application server 106 may generate a graph based on the one or more workflows comprising the one or more sub-tasks of the task. The graph may comprise one or more nodes and one or more edges. In an embodiment, each node in the graph may be a representative of the sub-task and each edge may connect two sub-tasks, from the one or more sub-tasks, which may be the representative of a sequence of processing the two sub-tasks.

In an embodiment, the application server 106 may extract the historical records pertaining to the one or more resources from the database server 104. In another embodiment, the application server 106 may receive the historical records from the requestor-computing device 102. In an embodiment, the application server 106 may utilize the historical records of each of the one or more resources to determine the set of performance attributes (e.g., a cost, delay, and accuracy for processing a task or a sub-task) for each of the one or more resources. In another embodiment, the application server 106 may receive or extract the set of performance attributes for each resource from the requestor-computing device 102 or the database server 104 over the network 108. In an embodiment, the application server 106 may segregate the one or more resources into one or more sets of resources based on one or more of, but not limited to, a count of the one or more sub-tasks, the one or more skills required for processing the one or more sub-tasks, and the one or more skills associated with the one or more resources. In an embodiment, each set of resources may comprise resources who may be available for processing the respective sub-tasks.

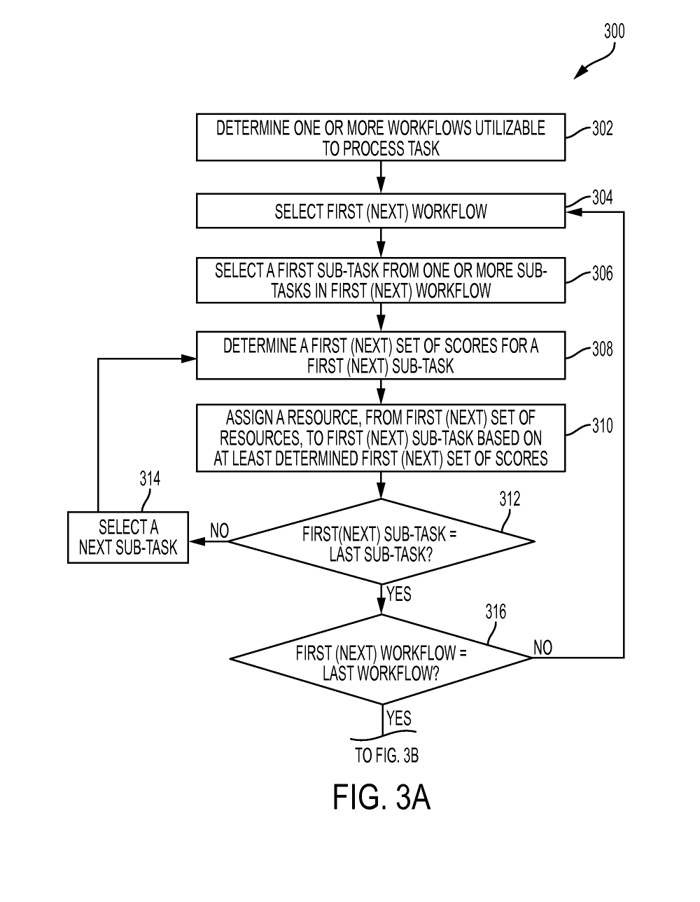

Thereafter, the application server 106 may allocate at least one resource, from each set of resources, to each sub-task. For example, the application server 106 may allocate a resource, from a first set of resources, to a first sub-task, wherein the first set of resources corresponds to resources who have been identified to process the first sub-task. To allocate the at least one resource, the application server 106 may determine a first set of scores corresponding to the first sub-task. The first set of scores is determined based on at least a first set of performance attributes of each resource, in the first set of resources. Further, in an embodiment, the application server 106 may assign the at least one resource, from the first set of resources, to process the first sub-task based on at least one of the first set of scores and the one or more requisites/constraints associated with the first sub-task. The one or more requisites/constraints associated with the first sub-task may be predefined by the requestor. The one or more requisites/constraints associated with the first sub-task may comprise a first cost constraint, a first time constraint, and a first accuracy constraint. In an embodiment, the resource, from the first set of resources, who may fulfill the one or more requisites/constraints associated with the first sub-task may be selected for processing the first sub-task. Similarly, the application server 106 may assign a resource to each of the one or more remaining sub-tasks corresponding to each workflow of the graph as discussed above. The assignment of the one or more resources to the one or more sub-tasks of the task will be explained later in conjunction with FIGS. 3A and 3B, FIG. 4, and FIG. 5.

After assigning the resources to each sub-task, the application server 106 may determine an estimated set of performance attributes for each sub-task. The estimated set of performance attributes, corresponding to each sub-task, is determined based on at least the first set of performance attributes of each resource assigned to each sub-task. Thereafter, the application server 106 may determine workflow's performance attributes for each workflow based on at least the estimated set of performance attributes of each of the one or more sub-tasks in each workflow. Further, the application server 106 may compare the workflow's performance attributes of each workflow with the workflow's performance attributes of remaining workflows. In an embodiment, the application server 106 may select one workflow, from the one or more workflows, for processing the task based on at least the comparison. In an embodiment, the workflow, from the one or more workflows, having the most efficient workflow's performance attributes (i.e., a minimum cost, a maximum accuracy, and a minimum delay) may be selected for processing the task.

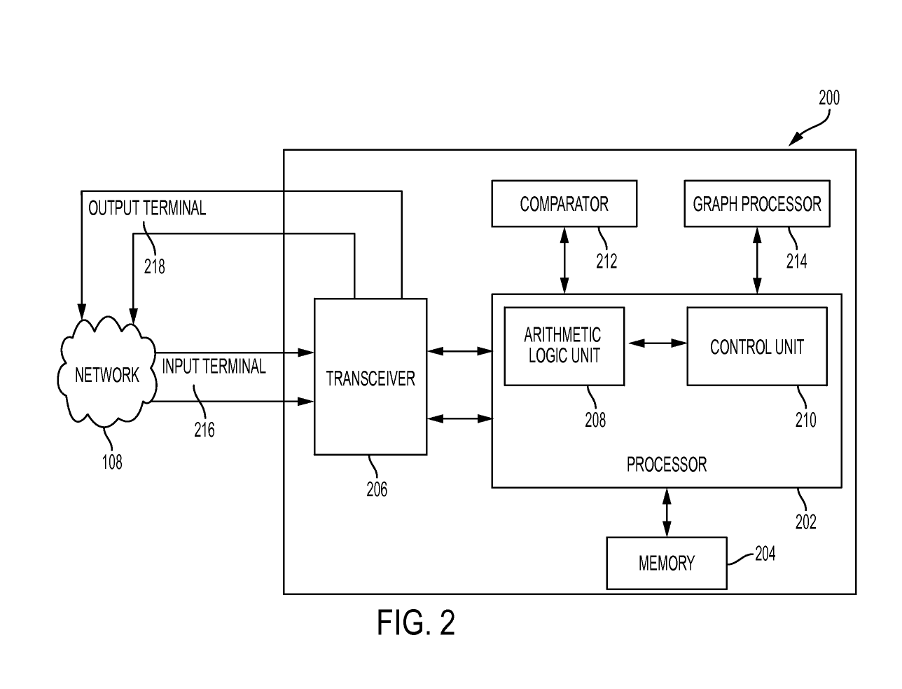

The application server 106 may be realized using various technologies such as, but not limited to, Java application server, .NET Framework, PHP, Base4 application server, and Appaserver. The application server 106 has been described later in conjunction with FIG. 2.

A person skilled in the art would understand that the scope of the disclosed invention should not be limited to the database server 104 or the application server 106 as a separate entity. In an embodiment, the functionalities of the database server 104 and the application server 106 may be combined into a single server, without limiting the scope of the disclosure.

The network 108 corresponds to a medium through which the information associated with the task and the information associated with the one or more resources may flow between one or more of, but not limited to, the requestor-computing device 102, the database server 104, and the application server 106. Examples of the network 108 may include, but are not limited to, a Wireless Fidelity (Wi-Fi) network, a Wide Area Network (WAN), a Local Area Network (LAN), or a Metropolitan Area Network (MAN). Various devices such as the requestor-computing device 102, the database server 104, and the application server 106 may connect to the network 108 in accordance with various wired and wireless communication protocols such as Transmission Control Protocol/Internet Protocol (TCP/IP), User Datagram Protocol (UDP), and 2G, 3G, or 4G communication protocols.

FIG. 2 is a block diagram illustrating a system 200 for assigning the one or more resources to the task, in accordance with at least one embodiment. The system 200 may comprise one or more processors, such as a processor 202, one or more memories, such as a memory 204, one or more transceivers, such as a transceiver 206, one or more comparators, such as a comparator 212, and one or more graph processors, such as a graph processor 214. The transceiver 206 is coupled with an input terminal 216 and an output terminal 218.

The system 200 may correspond to the requestor-computing device 102 or the application server 106 without departing from the scope of the disclosure. For the purpose of the ongoing description, the system 200 has been considered as the application server 106. However, a person skilled in the art will understand that the system 200 may be realized as the requestor-computing device 102 without departing from the spirit of the disclosure.

The processor 202 may be configured to execute a set of instructions stored in the memory 204 to perform one or more operations. The processor 202 may be coupled to the memory 204, the transceiver 206, the comparator 212, and the graph processor 214. The processor 202 may comprise one or more arithmetic logic units such as an arithmetic logic unit (ALU) 208 and one or more control units such as a control unit 210. The ALU 208 may be coupled to the control unit 210. The ALU 208 may be operable to perform one or more mathematical and logical operations and the control unit 210 may be configured to control the operation of the ALU 208. Though, the ALU 208 and the control unit 210 are implemented within the processor 202 in FIG. 2, a person skilled in the art would appreciate that the ALU 208 and the control unit 210 may be implemented independently from the processor 202 without departing from the scope of the disclosure. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions/queries and the information associated with the one or more resources and the task. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 may be operable to communicate with the one or more devices, such as the requestor-computing device 102, and/or one or more servers, such as the database server 104 over the network 108. The transceiver 206 may be operable to transmit or receive the instructions/queries or other information to/from various components of the system environment 100. In an embodiment, the transceiver 206 is coupled to the input terminal 216 and the output terminal 218 through which the transceiver 206 may receive or transmit instructions/queries or other information corresponding to the assigning/staffing of the one or more resources to the task (or the one or more sub-tasks of the task). In an embodiment, the input terminal 216 and the output terminal 218 may be realized through, but are not limited to, an antenna, an Ethernet port, an USB port or any other port that can be configured to receive and transmit data. The transceiver 206 may receive and transmit various data in accordance with various communication protocols such as, TCP/IP, UDP, and 2G, 3G, or 4G communication protocols through the input terminal 216 and the output terminal 218, respectively.

The comparator 212 is configured to compare at least two input signals to generate an output signal. In an embodiment, the output signal may correspond to either “1” or “0.” In an embodiment, the comparator 212 may generate output “1” if the value of a first signal (from the at least two signals) is greater than a value of the second signal (from the at least two signals). Similarly, the comparator 212 may generate an output “0” if the value of the first signal is less than the value of the second signal. In an embodiment, the comparator 212 may be realized through either software technologies or hardware technologies known in the art. Though, the comparator 212 is depicted as independent from the processor 202 in FIG. 2, a person skilled in the art would appreciate that the comparator 212 may be implemented within the processor 202 without departing from the scope of the disclosure.

The graph processor 214 may be configured to execute a set of instructions stored in the memory 204 to perform one or more predetermined operations. In an embodiment, the graph processor 214 may comprise suitable logic, circuitry, and/or interfaces that may be operable to execute one or more instructions stored in the memory 204 to generate the graph. In an embodiment, the graph processor 214 may utilize the information associated with the tasks such as the one or more sub-tasks of the task and one or more sequences of processing the one or more sub-tasks, stored in the database server 104 or the memory 204, to generate the graph. Further, in an embodiment, the graph processor 214 may be configured to represent each of the one or more sub-tasks of the task with a node in the graph and the sequence of processing the two sub-tasks as each edge between the pair of nodes. The graph processor 214 may be implemented using one or more processor technologies known in the art. Examples of the graph processor 214 include, but are not limited to, an x86 microprocessor, an ARM microprocessor, an X86-based processor, a Reduced Instruction Set Computing (RISC) processor, an Application-Specific Integrated Circuit (ASIC) processor, and/or a Complex Instruction Set Computing (CISC) processor.

A person skilled in the art would understand that the scope of the disclosure should not be limited to the processor 202 and the graph processor 214 as separate entities. In an embodiment, the functionalities of the processor 202 and the graph processor 214 may be combined into a single processor without limiting the scope of the disclosure.

FIGS. 3A and 3B are flowcharts 300 illustrating a method for assigning the one or more resources to the task, in accordance with at least one embodiment. The flowchart 300 is described in conjunction with FIG. 1 and FIG. 2. Further, FIG. 3A includes steps from 302 to 316 and FIG. 3B includes steps from 318 to 324 of the disclosed method for assigning the one or more resources to the task.

At step 302, the one or more workflows to process the task are determined. In an embodiment, the processor 202 may be configured to determine the one or more workflows to process the task. Each of the one or more workflows may comprise the one or more sub-tasks of the task. In an embodiment, the processing of any of the workflow, from the one or more workflows, may in-turn process the task as a whole.

In an embodiment, the processor 202 may extract the task and the associated information from the database server 104. In another embodiment, the processor 202 may receive the task and the associated information from the requestor-computing device 102. The associated information may comprise one or more of, but not limited to, the one or more requisites/constraints (e.g., the cost constraint, the delay constraint, the accuracy constraint, etc.) of the task, the deadline for processing the task, and the one or more skills required for processing the task. The associated information may further comprise one or more instructions for creating the one or more sub-tasks from the task and thereafter, the one or more workflows using the created one or more sub-tasks. Post extracting/receiving the associated information, the processor 202 may store the associated information in the memory 204. Concurrently, the processor 202 may utilize the associated information and the one or more instructions associated with the task, to create the one or more sub-tasks. In another embodiment, the processor 202 may receive or extract the one or more sub-tasks of the task from the requestor-computing device 102 or the database server 104. Post creating or receiving the one or more sub-tasks, the processor 202 may create one or more workflows based on the one or more instructions associated with the task (or the one or more sub-tasks).

For example, the processor 202 may receive a task to digitize a handwritten document. Further, the processor 202 may receive an associated information with the digitization task. For instance, the associated information may include one or more instructions to check blank fields in the handwritten document or check data types of text written in one or more fields for any ambiguities. The processor 202 may utilize the one or more instructions to determine that the digitization of the handwritten document involve a sub-task to check for the blank fields and another sub-task to check for any ambiguities in the data types. Thereafter, the processor 202 may determine, from the historical data pertaining to processing of the digitization tasks, that the digitization of the handwritten document further involves scanning the handwritten document. Hence, the workflow to digitize the handwritten document may involve scanning the handwritten document, check for blank fields in the document, and check the data types of the text written in the one or more fields. In an embodiment, the processor 202 may further determine, from the historical data, that the sub-tasks related to checking for blank fields and checking the data types of the fields may be performed using automated tools or may be performed through means of crowdsourcing. Therefore, the processor 202 may define two workflows to digitize the handwritten document. The first workflow may use automated tools and the second workflow may be performed through crowdsourcing. The first workflow may include sub-tasks related to scanning the handwritten document, checking for the blank fields, and checking the data types of the text written in the one or more fields. On the other hand the second workflow may include the one or more sub-tasks related to scanning the handwritten document, crowdsourcing the electronic document asking the workers to check for blank fields, validating the responses of the workers, crowdsourcing the electronic document asking the workers to check for the data types of the text written in the fields, validating the responses received from the workers.

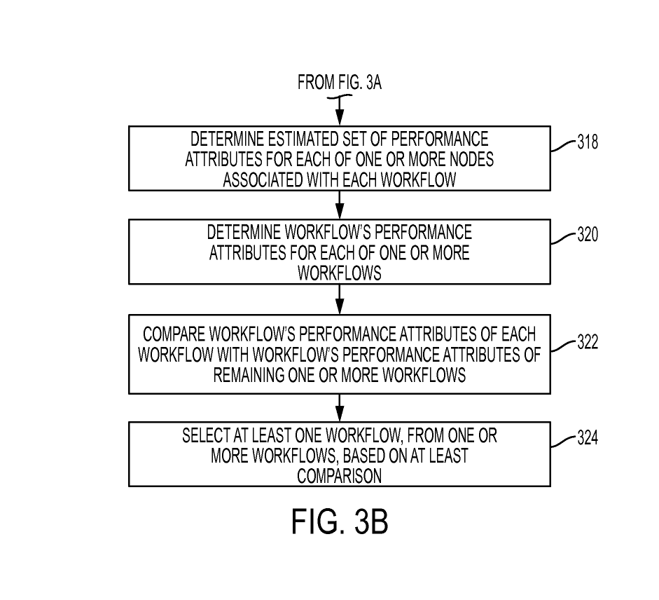

Post creation of the one or more workflows, in an embodiment, the graph processor 214 may be configured to generate the graph representing the one or more workflows of the task. The generated graph may comprise the one or more nodes and the one or more edges. Each of the one or more nodes in the graph may represent a sub-task from the one or more sub-tasks. Further each edge may connect two sub-tasks, from the one or more sub-tasks, which may be the representative of the sequence of processing the two sub-tasks. In an embodiment, the generated graph may be a directed acyclic graph, wherein a direction of an edge from one node to another node may be the representative of the sequence of processing the two sub-tasks. The generation of the graph will be explained later in conjunction with FIG. 4.

Further, in an embodiment, the processor 202 may extract the historical records of the one or more resources from the database server 104. In an embodiment, the one or more resources may comprise at least one or more of, but are not limited to, one or more employees, one or more crowdsourcing platforms, one or more organizations, one or more hardware and one or more software. The historical records of each of the one or more resources may comprise one or more of, but not limited to, the one or more skills associated with each of the one or more resources, the time took by each of the one or more resources to process the one or more historical sub-tasks (or the historical tasks), the accuracy attained by the one or more resources on the one or more historical sub-tasks (or the historical tasks), and the cost charged by each of the one or more resources to process the one or more historical sub-tasks (or the historical tasks). After receiving the historical records, the processor 202 may segregate the one or more resources into the one or more sets of resources based on at least one or more of, but not limited to, the count of the one or more sub-tasks, the one or more skills required for processing the one or more sub-tasks, the one or more skills associated with the one or more resources, and the set of performance attributes (e.g., the cost, delay, accuracy, for processing a task or a sub-task) associated with each of the one or more resources. For example, a task comprises two sub-tasks. A first sub-task requires two mechanical engineers to process it and a second sub-task requires three computer science engineers to process it. There are a total of 50 resources and out of 50 resources, of which five are mechanical engineers and eight are computer science engineers. In such a case, the processor 202 may include the five mechanical engineers in a first set of resources (that may be utilized to process the first sub-task). Further, the processor 202 may include the eight computer science engineers in a second set of resources (that may be utilized to process the second sub-task).

In an embodiment, each set of resources may be utilized to process a sub-task, from the one or more sub-tasks, associated with each workflow. Therefore, the count of the one or more sets of the resources may depend on the count of the one or more nodes (i.e., the one or more sub-tasks) in each workflow of the graph. In an embodiment, the segregation of the one or more resources in the one or more sets of the resources may be different for different workflows. Further, the count of the one or more sets of the resources may also be different for different workflows.

At step 304, a first workflow, from the one or more workflows, is selected. In an embodiment, the processor 202 may select the first workflow. As discussed, each workflow may comprise the one or more sub-tasks of the task such that each workflow may be utilized to process the task as a whole. The one or more sub-tasks, in each workflow, may be interdependent on each other. For example, interdependency among one or more sub-tasks may involve executing the one or more sub-tasks in a sequence such that the sub-task succeeding a first sub-task may not be processed unless the first sub-task has been processed. A person having ordinary skills in the art will appreciate that a sub-task, from the one or more sub-tasks of the task, may be a part of more than one workflows without limiting the scope of the disclosure.

At step 306, the first sub-task, from the one or more sub-tasks in the first workflow, is selected. In an embodiment, the processor 202 may select the first sub-task from the one or more sub-tasks associated with the first workflow.

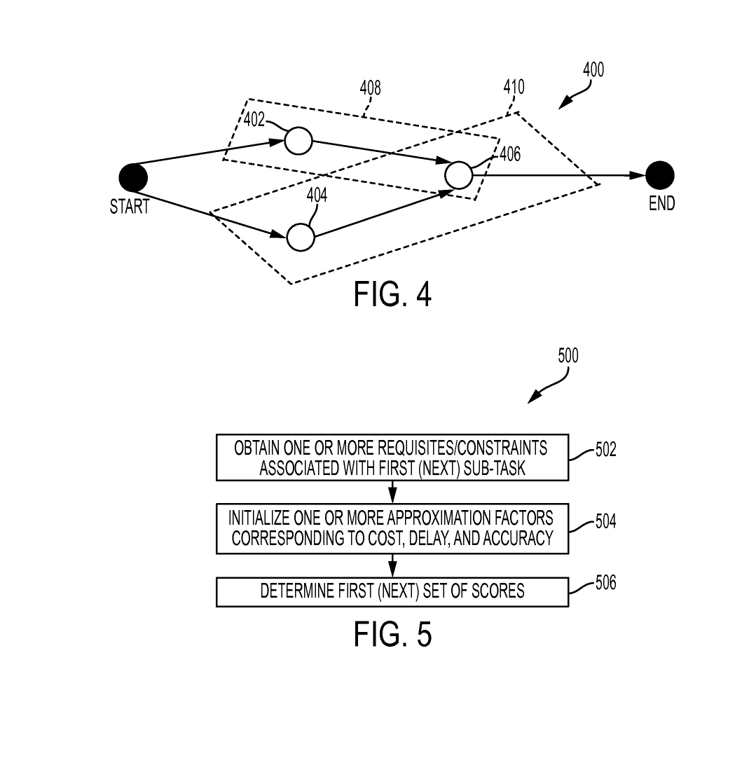

At step 308, the first set of scores is determined for the first sub-task. In an embodiment, the ALU 208 may be configured to determine the first set of scores corresponding to the first sub-task. In an embodiment, the first set of scores may signify an availability of the first set of resources, associated with the first sub-task, for processing the first sub-task. In an embodiment, the first set of scores may be determined based on the first set of performance attributes associated with each resource in the first set of resources and the one or more requisites/constraints associated with the first sub-task under consideration (i.e., sub-task selected in the step 306). The determination of the first set of scores corresponding to the first sub-task of the first workflow will be explained later in conjunction with FIG. 5.

At step 310, a resource, from the first set of resources, is assigned to the first sub-task. In an embodiment, the processor 202 may assign the resource, from the first set of resources, to the first sub-task. In an embodiment, the processor 202 may assign the resource based on at least the first set of scores and the one or more requisites/constraints associated with the first sub-task. The one or more requisites/constraints associated with the first sub-task may imply that a cost of processing the first sub-task should not exceed the first cost constraint, a delay in processing the first sub-task should not be more than the first time constraint, and an accuracy of completed first sub-task should not be less than the first accuracy constraint. The assignment of the resource to the first sub-task associated with the first workflow will be explained later with an illustrative example in conjunction with FIG. 5.

At step 312, a check is performed to determine if the first sub-task is the last sub-task in the first workflow (selected in the step 304). In an embodiment, the comparator 212 may be configured to determine if the first sub-task is the last sub-task of the first workflow. For example, the first workflow comprises N sub-tasks connected to each other in a sequence. The processor 202 may initialize a count to the first sub-task of the first workflow as i=1. Thereafter, the comparator 212 may compare i with N i.e., (i≧N). If at step 312, the comparator 212 determines that (i≦N), then step 314 is performed. If at step 312, the comparator 212 determines that (i≧N), then step 316 is performed.

At step 314, a next sub-task is selected. In an embodiment, the processor 202 may select the next sub-task from the one or more sub-tasks of the first workflow. In an embodiment, the next sub-task may correspond to the sub-task (i=i+1 i. e. i=2) connected to the first sub-task and further succeeding the first sub-task. Post selecting the next sub-task (i=2), the processor 202 may perform the step 308 and step 310 to assign the resource to the next sub-task (i=2). Similarly, the processor 202 may repeat the step 308 and 310 for each of the one or more remaining sub-tasks until at least one resource is assigned to each of the one or more remaining sub-tasks associated with the first workflow (i.e., till i≧N).

At step 316, a check is performed to determine if the first workflow is a last workflow. In an embodiment, the comparator 212 may be configured to determine if the first workflow is the last workflow of the graph. For example, the graph comprises W workflows such that each workflow may be utilized to process the task. The processor 202 may initialize a count to the first workflow as W_{wf}=1. Thereafter, the comparator 212 may compare W_{wf} with W, i.e., (W_{wf}≧W). If at step 316, the comparator 212 determines that (W_{wf}≦W), then the processor 202 may select the next workflow (W_{wf}=W_{wf}+1 i. e. W_{wf}=2) and thereafter, the processor 202 may repeat the processes from step 304 to step 312 for the next workflow (W_{wf}=2). Similarly, the processor 202 may repeat the steps from step 304 to 312 for each of the one or more remaining workflows of the graph until (W_{wf}≧W). If at step 316, the comparator 212 determines that (W_{wf}≧W), then step 318 is performed.

At step 318, the estimated set of performance attributes is determined for each of the one or more sub-tasks associated with each workflow. In an embodiment, the ALU 208 may be configured to determine the estimated set of performance attributes for each of the one or more sub-tasks (each sub-task is represented by a node) associated with each workflow. The estimated set of performance attributes, for a sub-task associated with a workflow, may be determined based on at least the first set of performance attributes associated with a resource assigned to the sub-task under consideration. The processor 202 may further utilize the estimated set of performance attributes of a set of sub-tasks, from the one or more sub-tasks, preceding the sub-task under consideration associated with the workflow. In an embodiment, the ALU 208 may utilize the following equations to determine the estimated set of performance attributes (aᵢ, dᵢ, and cᵢ) corresponding to a node i (each node represent a sub-task) associated with each workflow:

aᵢ=Σ_{jεR}_{ᵢ}xᵢ^{j}*Aᵢ^{j}*aᵢ^{prev} (1)

where,

aᵢ: Accuracy associated with a node i;

xᵢ^{j}: Represents an indicator variable which is 1 if the sub-task (denoted by the node i) is assigned to a resource Rᵢ^{j} else 0;

Aᵢ^{j}: Represents accuracy associated with the resource Rᵢ^{j};

aᵢ^{prev}: Represents accuracy associated with a previous node (i−1); and

aᵢ^{prev}=1 for i=1.

dᵢ=dᵢ^{prev}+Σ_{jεR}_{ᵢ}xᵢ^{j}*Dᵢ^{j} (2)

where,

dᵢ: Delay associated with a node i;

dᵢ^{prev}: Represents delay associated with a previous node (i−1);

Dᵢ^{j}: Represents delay associated with the resource Rᵢ^{j}; and

dᵢ^{prev}=0 for i=1.

cᵢ=cᵢ^{prev}+Σ_{jεR}_{ᵢ}xᵢ^{j}*Cᵢ^{j} (3)

where,

cᵢ: Cost associated with a node i;

cᵢ^{prev}: Represents cost associated with a previous node (i−1);

Cᵢ^{j}: Represents cost associated with the resource Rᵢ^{j}; and

cᵢ^{prev}=0 for i=1.

At step 320, the workflow's performance attributes is determined for each of the one or more workflows. In an embodiment, the ALU 208 may be configured to determine the workflow's performance attributes of each of the one or more workflows. In an embodiment, the workflow's performance attributes of each workflow may be determined based on at least the estimated set of performance attributes of each of the one or more sub-tasks associated with each workflow. In an embodiment, the workflow's performance attributes of each workflow may correspond to the estimated set of performance attributes of the last sub-task (i.e., a last node) in the each workflow. For example, consider a workflow comprising three sub-tasks. Each sub-task is represented by a node, i.e., a first sub-task is represented by a node i=1, a second sub-task is represented by a node i=2, and a third sub-task (i.e., a last sub-task) is represented by node i=3. Consider a first resource, having a cost attribute C1, is assigned to the first sub-task, a second resource, having a cost attribute C2, is assigned to the second sub-task, and a third resource, having a cost attribute C3, is assigned to the third sub-task. The ALU 208 may utilize the equation 3 to determine the estimated set of performance attributes for each node (i.e., i=1, 2, and 3). The estimated set of performance attributes associated with the second sub-task (represented by the node i=2) is equal to c₂=C1+C2. The estimated set of performance attributes associated with the third sub-task (i.e., the last sub-task represented by the node i=3) is equal to c₃=C1+C2+C3. Therefore, overall cost of processing the workflow may correspond to the estimated set of performance attributes associated with the last sub-task.

At step 322, the workflow's performance attributes of a workflow is compared with the workflow's performance attributes of the remaining workflows. In an embodiment, the comparator 212 may be further configured to compare the workflow's performance attributes of each workflow with the workflow's performance attributes of the remaining workflows of the graph.

At step 324, one workflow, from the one or more workflows of the graph, is selected. In an embodiment, the processor 202 may be configured to select at least one workflow, from the one or more workflows of the graph, for processing the task. In an embodiment, the processor 202 may select the one workflow based on at least the comparison of the workflow's performance attributes of each workflow with the workflow's performance attributes of the remaining workflows of the graph. In an embodiment, the processor 202 may select the workflow, from the one or more workflows, having the most efficient and feasible workflow's performance attributes (i.e., the minimum cost, the maximum accuracy, and the minimum delay) for processing the task.

A person having ordinary skills in the art will understand that the method for assigning resources to the task is not limited to the sequence of steps as described in FIGS. 3A and 3B. The steps may be processed in any sequence to assign the resources to the task.

FIG. 4 is a graph 400 illustrating the one or more sub-tasks and the one or more workflows, in accordance with an embodiment. The graph 400 is described in conjunction with FIG. 1, FIG. 2, and FIGS. 3A and 3B.

In an embodiment, the graph 400 may correspond to the task comprising three sub-tasks namely a sub-task-1 (depicted by 402), a sub-task-2 (depicted by 404), and a sub-task-3 (depicted by 406). The graph 400 further comprises two workflows namely workflow-1 (depicted by 408) and workflow-2 (depicted by 410). The workflow-1 (depicted by 408) comprises two sub-tasks (the sub-task-1 (depicted by 402) and the sub-task-3 (depicted by 406)). The workflow-2 (depicted by 410) comprises two sub-tasks (the sub-task-2 (depicted by 404) and the sub-task-3 (depicted by 406)). In an embodiment, the task may be processed by utilizing any of the two workflows. The processor 202 may assign at least one resource to each of the two sub-tasks corresponding to each workflow. Further, in an embodiment, the processor 202 may select one workflow, from the two workflows, based one at least the optimization of the one or more performance attributes associated with the each sub-task.

FIG. 5 is a flowchart 500 illustrating a method for assigning the resource to the first sub-task based on the first set of scores, in accordance with at least one embodiment. The flowchart 500 is described in conjunction with FIG. 1, FIG. 2, FIGS. 3A and 3B, and FIG. 4.

At step 502, the one or more requisites/constraints associated with the first sub-task are obtained. In an embodiment, the processor 202 may obtain the one or more requisites/constraints associated with the first sub-task from the memory 204. The one or more requisites/constraints associated with the first sub-task may comprise one or more of, but not limited to, the cost constraint, the delay constraint, and the accuracy constraint. For example, a cost constraint may correspond to a maximum acceptable cost c for processing a sub-task. A delay constraint may correspond to a maximum acceptable delay d for processing the sub-task. An accuracy constraint may correspond to a minimum acceptable accuracy a for processing the sub-task. In an embodiment, it may be assumed that the cost and the delay are additive and the accuracy is subtractive.

At step 504, one or more approximation factors corresponding to the cost, the delay, and the accuracy are initialized. In an embodiment, the processor 202 may initialize the one or more approximation factors corresponding to the cost, the delay, and the accuracy based on one or more predefined values or the one or more predefined instructions received from the requestor-computing device 102. The approximation factor for the cost may correspond to δ_{c}. The approximation factor for the delay may correspond to δ_{d}. The approximation factor for accuracy may correspond to δₐ. In an embodiment, the one or more approximation factors (δ_{c},δ_{d},δₐ) may be same for each of the one or more sub-tasks. In another embodiment, the one or more approximation factors (δ_{c},δ_{d},δₐ) may have different values for different sub-tasks. Further, in an embodiment, the one or more approximation factors, i.e., δ_{c}, δ_{d}, and δₐ corresponding to the cost, the delay, and the accuracy may be equal, i.e., δ_{c}=δ_{d}=δₐ=δ.

At step 506, the first set of scores is determined corresponding to the first sub-task of the first workflow. In an embodiment, the ALU 208 may be configured to determine the first set of scores corresponding to the first sub-task of the first workflow. In an embodiment, the first set of scores may correspond to a first data structure (or a first matrix). The first data structure may comprise one or more numerical values. Each numerical value may have an associated index in the first data structure. The numerical value corresponding to each index of the first data structure may be determined based on at least the first set of performance attributes of each resource in the first set of resources available to process the first sub-task. The ALU 208 may perform one or more mathematical and logical operations to determine the numerical value corresponding to each index of the first data structure. In an embodiment, a data type of the one or more numerical values pertaining to one or more indexes of the first data structure may correspond to at least one or more of, but not limited to, a numerical data type and a binary data type. In an embodiment, the ALU 208 may utilize the following one or more equations to determine the one or more numerical values of the first data structure (or the first set of scores):

R_{i,c,d,a}={jεRᵢ| [symbol] _{(k,i)in E}M[k][c−cᵢ^{j}][d−dᵢ^{j}][a+aᵢ^{j}]} (4)

M[i][c][d][a]=1 if R_{i,c,d,a}≠Ø (5)

For example, consider a four dimensional first data structure M[i] [c][d] [a]. In an embodiment, a first dimension may correspond to a node number i=1 to N where N is the number of nodes associated with each workflow. In an embodiment, a second dimension may correspond to the cost and may have

$$⌈ \frac{C}{δ} ⌉$$

entries which may represent costs such as {0, δ, 2δ, . . . . . . . . . ,

$$⌊ \frac{C}{δ} ⌋ . δ \} .$$

Similarly, a third dimension may correspond to the delay and may have

$$⌈ \frac{D}{δ} ⌉$$

entries which may represent delay such as {0, δ, 2δ, . . . . . . . . . ,

$$⌊ \frac{D}{δ} ⌋ . δ \} .$$

Similarly, a fourth dimension may correspond to the accuracy and may have

$$⌈ \frac{A}{δ} ⌉$$

entries which may represent accuracy such as {0, δ, 2δ, . . . . . . . . . ,

$$⌊ \frac{A}{δ} ⌋ . δ \} .$$

In an embodiment, one or more numerical values at one or more indexes of the first data structure (M[i] [c][d] [a]) may be equal to one (i.e., M[i] [c][d] [a]=1), when there is a feasible assignment of resources at the node i (node i=1 corresponds to the first sub-task) which may have accumulated cost at most c, delay at most d and accuracy at least a. Referring to FIG. 4, as discussed above, the graph 400 includes two workflows. Each workflow may be utilized to process the task. The workflow-1 (depicted by 408) comprises two sub-tasks (the sub-task-1 (depicted by 402) and the sub-task-3 (depicted by 406)). The workflow-2 (depicted by 410) comprises two sub-tasks (the sub-task-2 (depicted by 404) and the sub-task-3 (depicted by 406)). Consider there are six resources (R1, R2, R3, R4, R5, and R6) available for processing the three sub-tasks of the task. In an embodiment, the processor 202 may segregate the six resources into three set of resources based on the requirements of each sub-task. Let the first set of resources available for processing the sub-task-1 comprises two resources R1 and R2. Let the second set of resources available for processing the sub-task-2 comprises two resources R3 and R4. And let the workflow's resources available for processing the sub-task-3 comprises two resources R5 and R6. Further, each resource in each set of resources has a first set of performance attributes as shown in Table 1.

TABLE 1
Available resources and corresponding performance attributes

| | Sub-task it | | |
|---|---|---|---|
| Resource | can perform | Cost | Delay |
| R1 | Sub-task-1 | 2 | 2 |
| R2 | Sub-task-1 | 1 | 1 |
| R3 | Sub-task-2 | 2 | 2 |
| R4 | Sub-task-2 | 1 | 1 |
| R5 | Sub-task-3 | 2 | 2 |
| R6 | Sub-task-3 | 1 | 1 |

One or more requisites/constraints corresponding to the sub-task-1 (represented by node i=1) are C=2, D=2, and δ=0.5. Therefore, the second dimension has

$$⌈ \frac{C}{δ} ⌉ = ⌈ \frac{2}{0.5} ⌉ = 4$$

entries such as {0.5, 1, 1.5, 2}. Similarly, the third dimension has

$$⌈ \frac{D}{δ} ⌉ = ⌈ \frac{2}{0.5} ⌉ = 4$$

entries such as {0.5, 1, 1.5, 2}. Thereafter, the processor 202 may create an empty first data structure comprising one or more indexes with rows representing the cost of the sub-task-1 and columns representing the delay of the sub-task-1. Further, the ALU 208 may determine the one or more numerical values pertaining to the one or more indexes of the first data structure as shown in Table 2. A minimum cost and a minimum delay associated with a resource R1 is (2,2). The resource R1 may not be able to process the sub-task-1 when (c<2) and (d<2). In such a scenario, the processor 202 may assign 1 corresponding to an index (2,2) in the first data structure as shown in Table 2. A minimum cost and a minimum delay associated with a resource R2 is (1,1). The resource R2 may not be able to process the sub-task-1 when (c<1) and (d<1). In such a scenario, the processor 202 may assign 1 corresponding to an index (1,1) in the first data structure as shown in Table 2. Further, the processor 202 may identify that the resource R2 may process the sub-task-1 when (c>1) and (d>1) as the resource R1 may process the sub-task-1 in c=1 and d=1. In such a scenario, the processor 202 may assign 1 in the first data structure as shown in Table 2 corresponding to indexes (1,1.5), (1,2), (1.5, 1), (1.5, 1.5), (1.5,2), (2,1), and (2,1.5). Thereafter, the processor 202 may assign the resource R2 to process the sub-task-1 because the resource R2 can process the sub-task-1 in c=1 and d=1, which is more efficient and feasible than the resource R1 as shown in Table 2.

TABLE 2
Assignment of one or more parameters in a first data structure

| | d = .5 | d = 1 | d = 1.5 | d = 2 |
|---|---|---|---|---|
| c = .5 | 0 | 0 | 0 | 0 |
| c = 1 | 0 | 1 | 1 | 1 |
| c = 1.5 | 0 | 1 | 1 | 1 |
| c = 2 | 0 | 1 | 1 | 1 |

Similarly, the processor 202 may determine a second data structure and a third data structure corresponding to the sub-task-2 and the sub-task-3 as shown in Table 3 and Table 4. The processor 202 may assign the resource R4 to process the sub-task-2 because the resource R4 can process the sub-task-2 in c=1 and d=0.5, which is more efficient and feasible than the resource R3 as shown in Table 3. Further, the processor 202 may assign the resource R6 to process the sub-task-3 because the resource R6 can process the sub-task-3 in c=1 and d=1, which is more efficient and feasible than the resource R5 as shown in Table 4.

TABLE 3
Assignment of one or more parameters in a second data structure

| | d = .5 | d = 1 | d = 1.5 | d = 2 |
|---|---|---|---|---|
| c = .5 | 0 | 0 | 0 | 0 |
| c = 1 | 1 | 1 | 1 | 1 |
| c = 1.5 | 1 | 1 | 1 | 1 |
| c = 2 | 1 | 1 | 1 | 1 |

TABLE 4
Assignment of one or more parameters in a third data structure

| | d = .5 | d = 1 | d = 1.5 | d = 2 | d = 2.5 | d = 3 |
|---|---|---|---|---|---|---|
| c = .5 | 0 | 0 | 0 | 0 | 0 | 0 |
| c = 1 | 0 | 0 | 0 | 0 | 0 | 0 |
| c = 1.5 | 0 | 0 | 0 | 0 | 0 | 0 |
| c = 2 | 0 | 0 | 0 | 1 | 1 | 1 |
| c = 2.5 | 0 | 0 | 0 | 1 | 1 | 1 |
| c = 3 | 0 | 0 | 0 | 1 | 1 | 1 |

A person having ordinary skills in the art will understand that the method for determining the first set of scores is not limited to the sequence of steps as described in FIG. 5. The steps may be processed in any sequence to determine the first set of scores. Further, in an embodiment, the processor 202 may determine a second set of scores, a third set of scores, and so on corresponding to the second sub-task, the third sub-task, and so on associated with each workflow in a similar manner as discussed in conjunction with FIGS. 3A and 3B, FIG. 4, and FIG. 5. Further, the processor 202 may assign at least one resources to each sub-task associated with each workflow in a similar manner as discussed in conjunction with FIGS. 3A and 3B, FIG. 4, and FIG. 5.

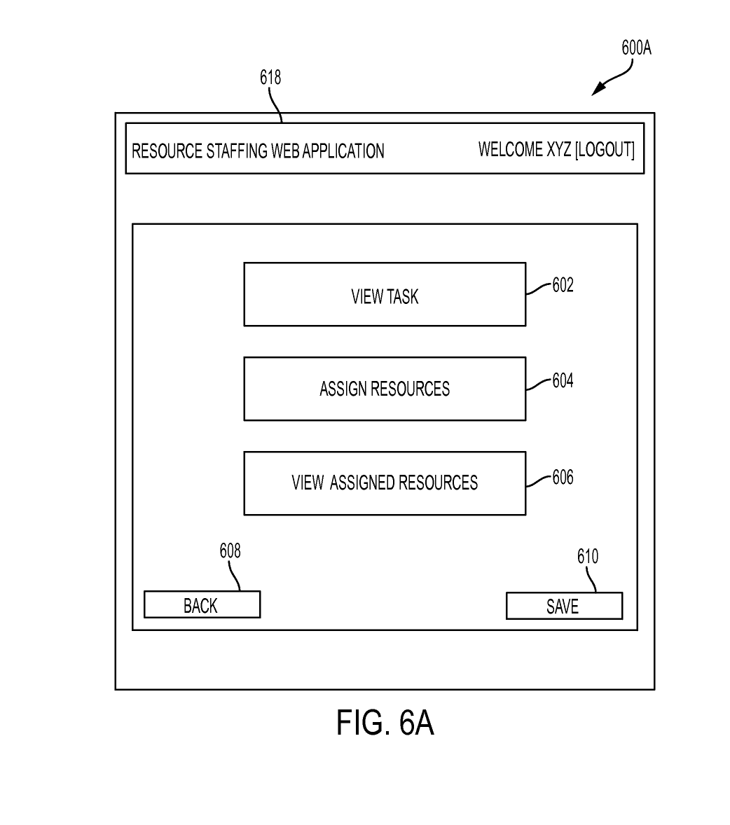

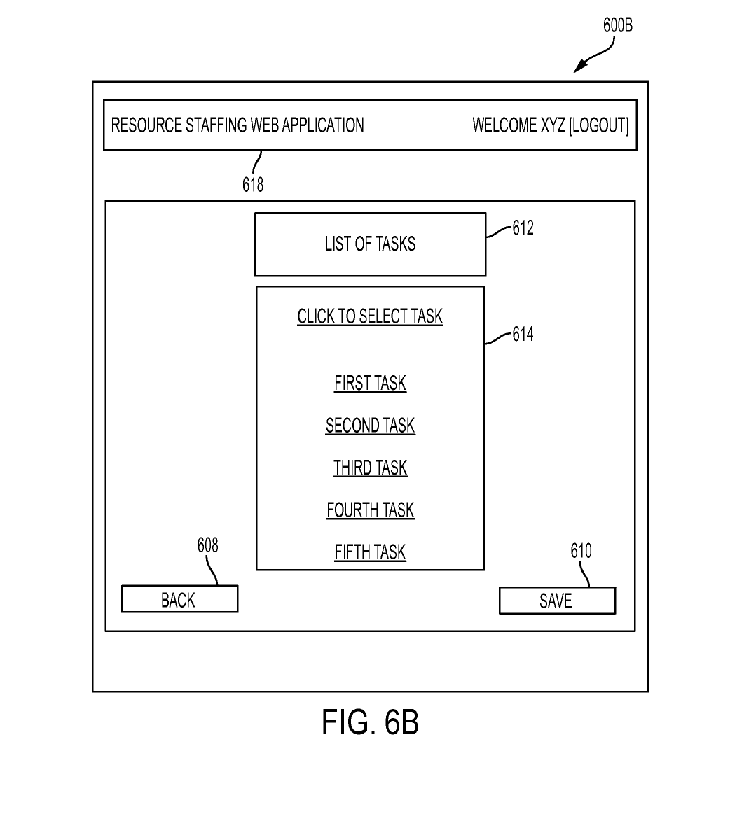

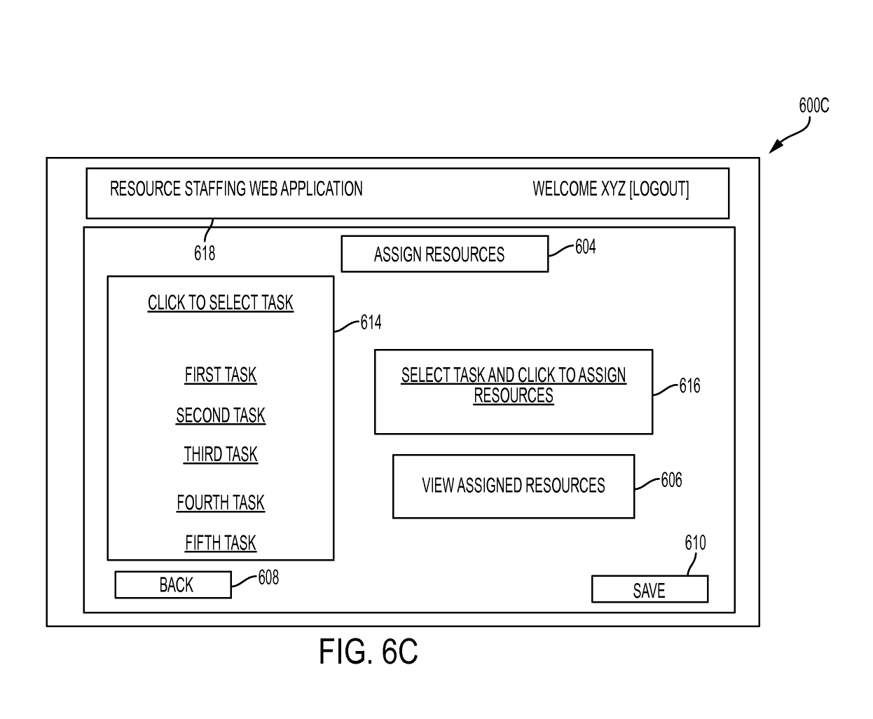

FIG. 6A is a block diagram illustrating the GUI 600A utilized by the requestor for viewing and assigning the resources to the task, in accordance with at least one embodiment. In an embodiment, the processor 202 may present the GUI 600A on the display screen of the computing device such as the requestor-computing device 102. The requestor may log into a resource staffing web application 618 using his/her user id and password. The processor 202 may present the GUI 600A to the requestor, when the requestor has logged in. The requestor may utilize the GUI 600A to view task, assign resources, and view assigned resources using one or more tabs such as a view task tab 602, a assign resources tab 604, and a view assigned resources tab 606.

FIG. 6B is a block diagram illustrating the GUI 600B utilized by the requestor for selecting the task, in accordance with at least one embodiment. In an embodiment, the processor 202 may present the GUI 600B on the display screen of the requestor-computing device 102, when the requestor may have clicked on the view task tab 602. The processor 202 may display a list of tasks (depicted by 612) on the GUI 600B. The requestor may click one of the displayed tasks to select the task (depicted by 614). In an embodiment, the requestor may click on a save tab 610 to save the selected task. Further, the requestor may click on a back tab 608 to go back to a previous GUI such as the GUI 600A.

FIG. 6C is a block diagram illustrating the GUI 600C utilized by the requestor for assigning the resources to the task, in accordance with at least one embodiment. In an embodiment, the processor 202 may present the GUI 600C on the display screen of the requestor-computing device 102, when the requestor may have selected the task from the one or more tasks displayed on the GUI 600B. In an embodiment, the requestor may click on a tab such as a select task and click to assign resources tab 616 to assign the resources corresponding to the selected task. In an embodiment, the requestor may click on the view assigned resources tab 606 to view the resources assigned to the task. In another embodiment, post clicking on the view assigned resources tab 606, the processor 202 may display the graph displaying the one or more workflows of the task. Further, the processor 202 may display the one or more resources assigned to the one or more sub-tasks associated with the selected workflow. The selected workflow may be utilized for processing the task. In an embodiment, the requestor may click on the save tab 610 to save any changes caused by him/her. Further, the requestor may click on the back tab 608 to go back to a previous GUI such as the GUI 600B.

The disclosed embodiments encompass numerous advantages. Various advantages of the disclosure include assigning one or more resources to one or more sub-tasks of a task. The task may be represented by one or more workflows comprising the one or more sub-tasks, such that each workflow may be utilized for processing the task as a whole. The one or more workflows may be represented as a directed acyclic graph. Further, the disclosed method may utilize a set of performance attributes (such as cost, delay, and accuracy) associated with each of the one or more resources available for processing each sub-task along with one or more constraints (such as cost, delay, and accuracy) associated with each sub-task for assigning the resource to each sub-task. The disclosed method assigns the resource to each sub-task such that a total cost of processing the task is minimized. Further, a delay in the processing of the task is also minimized and an overall accuracy of the completed task is maximized. Thus, the disclosed method assigns the resources to the task who are most efficient and feasible for processing the task.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for assigning one or more resources to a task have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for assigning, by a computing device, one or more resources to a task, said method comprising:
extracting, by one or more processors in said computing device, said task and associated information from a database server over a communication network;
determining, by said one or more processors, one or more workflows utilizable to process said task, wherein each of said one or more workflows defines a sequence of processing one or more sub-tasks to process said task;
for a workflow from said one or more workflows:
determine, by an arithmetic logic unit in said one or more processors, a first set of scores for a first sub-task, from said one or more sub-tasks, based on at least a first set of performance attributes of a first set of resources available to process said first sub-task, wherein said first set of scores is indicative of availability of said first set of resources to process said first sub-task; and
assigning, by said one or more processors, at least a resource from said first set of resources to said first sub-task based on at least one of said determined first set of scores and one or more requisites associated with said first sub-task; and
selecting, by said one or more processors, a workflow from said one or more workflows such that one or more performance attributes associated with said selected workflow are most efficient and feasible for said processing of said task, wherein at least said resource assigned to said first sub-task associated with said selected workflow is displayed on a user interface of a requestor computing device over the communication network.

2. The method of claim 1, wherein said one or more resources comprise at least one or more of a software, a hardware, one or more employees, one or more crowdsourcing platforms, and one or more organizations.

3. The method of claim 1 further comprising generating, by a graph processor, a directed acyclic graph (DAG) depicting said one or more workflows.

4. The method of claim 3, wherein said directed acyclic graph comprises one or more nodes and one or more edges, wherein each node, from said one or more nodes, corresponds to a sub-task and each edge, from said one or more edges, connects two sub-tasks from said one or more sub-tasks in said workflow to depict said sequence of processing said two sub-tasks.

5. The method of claim 1, wherein said first set of performance attributes comprise at least a measure of one or more of a cost, a delay, and an accuracy associated with each of said one or more resources.

6. A system for assigning, by a computing device, one or more resources to a task, said system comprising:
one or more processors in said computing device configured to:
extract said task and associated information from a database server over a communication network;
determine one or more workflows utilizable to process said task, wherein each of said one or more workflows defines a sequence of processing of one or more sub-tasks to process said task;
for a workflow from said one or more workflows:
determine, by an arithmetic logic unit in said one or more processors, a first set of scores for a first sub-task, from said one or more sub-tasks, based on at least a first set of performance attributes of a first set of resources available to process said first sub-task, wherein said first set of scores is indicative of availability of said first set of resources to process said first sub-task; and
assign at least a resource from said first set of resources to said first sub-task based on at least one of said determined first set of scores and one or more requisites associated with said first sub-task; and
select a workflow from said one or more workflows such that one or more performance attributes associated with said selected workflow are most efficient and feasible for said processing of said task, wherein at least said resource assigned to said first sub-task associated with said selected workflow is displayed on a user interface of a requestor computing device over the communication network.

7. The system of claim 6, wherein said one or more resources comprise at least one or more of a software, a hardware, one or more employees, one or more crowdsourcing platforms, and one or more organizations.

8. The system of claim 6, wherein a graph processor is configured to generate a directed acyclic graph (DAG) depicting said one or more workflows.

9. The system of claim 8, wherein said directed acyclic graph comprises one or more nodes and one or more edges, wherein each node, from said one or more nodes, corresponds to a sub-task and each edge, from said one or more edges, connects two sub-tasks from said one or more sub-tasks in said workflow to depict said sequence of processing said two sub-tasks.

10. The system of claim 6, wherein said first set of performance attributes comprise at least a measure of one or more of a cost, a delay, and an accuracy associated with each of said one or more resources.

11. The system of claim 6, wherein said arithmetic logic unit in said one on more processors are further configured to determine an estimated set of performance attributes for each of said one or more sub-tasks in said workflow based on at least said first set of performance attributes of each of said one or more resources assigned to each of said one or more sub-tasks in said workflow.

12. The system of claim 11, wherein said arithmetic logic unit in said one on more processors are further configured to determine performance attributes for each of said one or more workflows based on at least said estimated set of performance attributes of each of said one or more sub-tasks.

13. The system of claim 12 further comprising a comparator configured to compare said performance attributes of said workflow with performance attributes of remaining one or more workflows.

14. The system of claim 13, wherein said selection of said workflow, from said one or more workflows, is based on at least said comparison.

15. A method for assigning, by a computing device, one or more resources to a task, said method comprising:
extracting, by one or more processors in said computing device, said task and associated information from a database server over a communication network;
determining, by said one or more processors, one or more workflows utilizable to process said task, wherein each of said one or more workflows defines a sequence of processing of one or more sub-tasks to process said task;
for a workflow from said one or more workflows:
determining, by an arithmetic logic unit in said one or more processors, a first set of scores for a first sub-task, from said one or more sub-tasks, based on at least one of a first set of performance attributes of a first set of resources available to process said first sub-task, wherein said first set of scores is indicative of availability of said first set of resources to process said first sub-task;
assigning, by said one or more processors, at least a resource from said first set of resources to said first sub-task based on at least one of said determined first set of scores and one or more requisites associated with said first sub-task;
comparing, by a comparator in said one or more processors, performance attributes of said workflow with performance attributes of remaining one or more workflows; and
selecting, by said one or more processors, at least said workflow, from said one or more workflows, based on at least said comparison such that one or more performance attributes associated with said selected at least said workflow are most efficient and feasible for said processing of said task, wherein at least said resource assigned to said first sub-task associated with said selected workflow is displayed on a user interface of a requestor computing device over the communication network.

16. The method of claim 15 further comprising determining, by said arithmetic logic unit in said one on more processors, an estimated set of performance attributes for each of said one or more sub-tasks in said workflow based on at least said first set of performance attributes of each of said one or more resources assigned to each of said one or more sub-tasks in said workflow.

17. The method of claim 16, wherein performance attributes for each of said one or more workflows is determined, by said arithmetic logic unit in said one on more processors, based on at least said estimated set of performance attributes of each of said one or more sub-tasks.

18. A computer program product for use with a computer, the computer program product comprising a non-transitory computer readable medium, wherein the non-transitory computer readable medium stores a computer program code for assigning one or more resources to a task, wherein the computer program code is executable by one or more processors to:
extract said task and associated information from a database server over a communication network;
determine one or more workflows utilizable to process said task, wherein each of said one or more workflows defines a sequence of processing of one or more sub-tasks to process said task;
for a workflow from said one or more workflows:
determine, by an arithmetic logic unit in said one or more processors, a first set of scores for a first sub-task, from said one or more sub-tasks, based on at least one of a first set of performance attributes of a first set of resources available to process said first sub-task, wherein said set of scores is indicative of availability of said first set of resources to process said first sub-task; and
assign at least a resource from said first set of resources to said first sub-task based on at least one of said determined first set of scores and one or more requisites associated with said first sub-task; and
select a workflow from said one or more workflows such that one or more performance attributes associated with said selected workflow are most efficient and feasible for said processing of said task, wherein at least said resource assigned to said first sub-task associated with said selected workflow is displayed on a user interface of a requestor computing device over the communication network.

19. A computer program product for use with a computer, the computer program product comprising a non-transitory computer readable medium, wherein the non-transitory computer readable medium stores a computer program code for assigning one or more resources to a task, wherein the computer program code is executable by one or more processors to:
extract said task and associated information from a database server over a communication network;
determine one or more workflows utilizable to process said task, wherein each of said one or more workflows defines a sequence of processing of one or more sub-tasks to process said task;
for a workflow from said one or more workflows:
determine, by an arithmetic logic unit in said one or more processors, a first set of scores for a first sub-task, from said one or more sub-tasks, based on at least one of a first set of performance attributes of a first set of resources available to process said first sub-task, wherein said first set of scores is indicative of availability of said first set of resources to process said first sub-task;
assign at least a resource from said first set of resources to said first sub-task based on at least one of said determined set of scores and one or more requisites associated with said first sub-task;
compare, by a comparator, performance attributes of said workflow with performance attributes of remaining one or more workflows; and
select at least said workflow, at least said workflow, from said one or more workflows, based on at least said comparison such that one or more performance attributes associated with said selected at least said workflow are most efficient and feasible for said processing of said task, wherein at least said resource assigned to said first sub-task associated with said selected workflow is displayed on a user interface of a requestor computing device over the communication network.

20. The method of claim 1, wherein said most efficient and feasible said one or more performance attributes associated with said selected at least said workflow correspond to minimum processing cost, minimum delay, and maximum accuracy for said processing of said task.
